(19) United States
(12) Patent Application Publication
(10) Pub. No.: US 2002/0119805 A1
(43) Pub. Date: Aug. 29, 2002

(54) Chilled transceiver

(76) Inventor: Andrew D. Smith, Redondo Beach, CA (US)

Correspondence Address: Patent Counsel, TRW Inc., S&EG Law Department, E2/6051, One Space Park, Redondo Beach, CA, 90278, US

(21) Appl. No.: 09/794,433

(22) Filed: Feb. 27, 2001

(51) Int. Cl. H04B 1/38

(52) U.S. Cl. 455/561; 455/217; 455/117

(57) ABSTRACT

A chilled transceiver for use in terrestrial and satellite communication systems. The chilled transceiver eliminates various problems associated with transceivers which incorporate superconducting devices. In particular, the chilled transceiver is based entirely upon conventional semiconductor technology, such as heterojunction bipolar transistor (HBT) technology formed from conventional GaAs, AlGaAs and InP materials which when chilled to temperatures down to, for example, 100° K can provide a 50% improvement in noise while trimming power losses by 20% or more at the same time. In one embodiment of the invention, the chilled transceiver is formed with a chilled receiver front end which includes a frequency diplexer, a filter, a low-noise amplifier (LNA) and a mixer, formed from conventional semiconductor technology which are housed in a refrigerator typically used for superconducting circuits. Since the receiver front end is formed from conventional semiconductor technology compatibility problems with the balance of the transceiver circuit is eliminated.

### BACKGROUND OF THE INVENTION

1. Field of the Invention

The present invention relates to a communication system and more particularly to a transceiver for use in, for example, a cellular telephone communications system, in which various components of the receiver are formed from non-superconducting materials, such as GaAs, AlGaAs and InP, and chilled to a temperature down to, for example, 100° K, in order to improve the noise figure which improves the signal-to-noise ratio of the signals and thus the sensitivity of the receiver as well as reducing losses in the transmitter.

2. Description of the Prior Art

Cellular, PCS and various other types of terrestrial mobile radio communication systems are linked together by a number of cells. Normally, geographic areas are subdivided into a number cell sites with one cell per area. Each cell site includes a base station for handling call traffic within its geographical area. Each base station includes a receiver and a transmitter forming a transceiver to provide a bi-directional communication link with terrestrial mobile radio communication users within the cell area. The capability of the transceivers in such base stations is limited by the selectivity and sensitivity of the transceiver as well as the losses of the transceiver.

In order to improve the selectivity and thus sensitivity of the transducer as well as to reduce the losses of the base station, superconducting devices have been incorporated into such transceiver systems. The use of superconducting circuits in such an application is well documented in the literature, for example, as disclosed in: “Design and Performance of Low-Noise Hybrid Superconducting/Semiconductor 7.4 GHz Receiver Downconverter,” by Barner et al., IEEE Transactions on Applied Superconductivity, Vol. 5, Issue 2, Part 3, pages 2075-2078, June 1995; “Development of a Compact Dual Frequency SIS Receiver,” by Liao et al., 4^{th} International Conference on Millimeter Wave and Far Infrared Science and Technology, pages 137-140, Aug. 12-15, 1996; “A Hybrid Superconductive/Semiconductor Microwave Receiver” Romano et al., IEEE Transactions on Applied Superconductivity, Vol. 7, Issue 2, Part 3, pages 3067-3070, Aug. 25-30, 1996; “HTS-Technology for UMTS Radio Base Stations,” by Chalopka et al., 9^{th} IEEE International Symposium on Personal, Indoor and Mobile Radio Communications, Vol. 3, pages 1255-1259, Sep. 8-11, 1998; “A 530-GHz Balanced Mixer,” by Chattopadhyay et al., IEEE Microwave and Guided Wave Letters, Vol. 9, Issue 11, pages 467-469, November 1999; “An HTS Transceiver for Third Generation Mobile Communications,” by Greed et al., IEEE Transactions on Applied Superconductivity, Vol. 9, Issue 2, Part 3, pages 4002-4005, Sep. 13-18, 1998; “Simulation of Conversion Gain and Reflectivity Coefficience in Heterodyne Detector Using a Superconductor-Normal Metal Superconductor Region,” by Luiz et al., IEEE Transactions on Applied Superconductivity, Vol. 9, Issue 2, Part 3, pages 44-48-44-51, Sep. 14-18, 1998; “RSFQ Front-End for a Software Radio Receiver,” IEEE Transactions on Applied Superconductivity, by Wikborg et al., Vol. 9, Issue 2, Part 3, pages 3615-3618, Sep. 13-18, 1998; “Superconductors and Cryotechnology for Future Space Communication Technology-the BOSCH Demonstrator Experiment,” by Klauda et al., 1999 IEEE MTT-S International Microwave Symposium Digest, Vol. 3, pages 1381-1384, Jun. 13-19, 1999; “A 350-GHz SIS Antipodal Finline Mixer,” by Yassin et al., IEEE Transactions on Microwave Theory and Techniques, Vol. 48, Issue 4, Part 2, pages 662-669, April 2000; and “A Dual-Polarized Quasi-Optical SIS Mixer at 550 GHz,” by Chattopadhyay et al., IEEE Transactions on Microwave Theory and Techniques, Vol. 48, Issue 10, pages 1680-1686, October 2000.

The use of superconducting devices in such systems is also disclosed in: U.S. Pat. Nos. 5,244,869; 5,455,594; 5,963,351; and 6,104,934. 5,244,869 relates to a superconducting microwave frequency selected filter system for improving selectivity and reducing the loss of a base station receiver. U.S. Pat. No. 5,455,594 discloses a superconducting array antennae for use in both satellite and terrestrial communication systems. U.S. Pat. No. 5,963,351 discloses a digital optical receiver with instantaneous Josephson clock recovery circuit. U.S. Pat. No. 6,104,934 relates to a cryoelectronic receiver front end. This patent discloses the use of a superconducting filter and amplifier for a receiver front end for use in a base station receiver for a terrestrial mobile radio communication system.

Various commercial embodiments of receivers for base stations applications are available from Superconductor Technologies, Inc.; Conductus; and Illinois Superconductor Corporation. The systems produced by these companies utilize superconducting filters for use in the receiver front end for base station receivers in order to improve the selectivity of the receiver as well as to reduce losses. Examples of such filters are disclosed in U.S. Pat. Nos. 5,932,522 and 6,130,189.

There are several problems with receiver systems with incorporate superconducting circuits. First, such superconducting circuits are generally not compatible with commercial off-the-shelf receiver components, such as amplifiers, filters and mixers. In addition, superconducting transceiver components are normally designed with redundancy to accommodate cooler failure. Thus, there is a need for a base station receiver which does not incorporate superconducting circuits but which can provide a lower noise figure and thus improve sensitivity and lower losses than base station receivers based on conventional semiconductor technology.

### SUMMARY OF THE INVENTION

The present invention relates to a chilled receiver for use in terrestrial and satellite communication systems, such as cellular and PCS mobile radio communication systems. The chilled transceiver eliminates various problems associated with transceivers which incorporate superconducting devices. In particular, the chilled receiver in accordance with the present invention is based entirely upon conventional semiconductor technology, such as heterojunction bipolar transistor (HBT) technology formed from conventional GaAs, AlGaAs and InP semiconductor materials which when chilled to temperatures down to, for example, 100° K can provide, for example, a 50% improvement in the noise figure while trimming power losses by 20% or more at the same time. In one embodiment of the invention, the chilled transceiver is formed with a chilled receiver front end which includes a frequency diplexer, a filter, a low-noise amplifier (LNA) and a mixer, formed from conventional semiconductor technology which are housed in a refrigerator typically used for superconducting circuits. Since the receiver front end is formed from conventional semiconductor technology compatibility problems with the balance of the transceiver circuit is eliminated.

### DESCRIPTION OF THE DRAWINGS

These and other advantages of the present invention will be readily understood with reference to the following specification and attached drawings wherein:

FIG. 1 is a block diagram of the chilled receiver in accordance with the present invention.

FIG. 2 is a graphical illustration of the noise figure as a function of temperature of the chilled receiver in accordance with the present invention.

FIG. 3 is a graphical illustration of the insertion loss of the transmit and receive channels as a function frequency of a K & L Model No. WSD-00064 duplexer at 80° K and 290° K.

FIG. 4 is an enlarged view of the insertion loss for a K & L Model No. WSD-00064 duplexer which illustrates that the receive channel insertion loss is received to zero when cooled to 80° K.

FIG. 5 is a graphical illustration third order intercept IP3 as a function of temperature for a TRW Model No. IMA-8 mixer at several different frequencies.

### DETAILED DESCRIPTION OF THE INVENTION

The present invention relates to a transceiver for use in satellite and terrestrial mobile communication systems which provides improved noise figure performance and reduced losses. An important aspect of the invention is that all of the components are formed from conventional semiconductor technology. In terrestrial mobile communication systems, such as cellular and PCS mobile communication systems, the system in accordance with the present invention is able to provide about a 50% improvement in noise figure and performance while reducing power losses by 20% at the same time using conventional semiconductor technology. By improving the noise figure performance of the system, the selectivity and sensitivity of the receiver is improved, which, in turn, improves the signal-to-noise ratio of the signals resulting in relatively higher quality voice and data transmissions as well as minimizing the number of calls dropped by cells thus improving customer satisfaction.

Although the principles of the present invention are shown and illustrated as only being applied to the receiver front end, these principles can basically be applied to any number of components in the transceiver. For example, the principles of the present invention can be applied to one or more MMICs forming virtually any portion of the transceiver.

One embodiment of the invention is illustrated in FIG. 1. In this embodiment, a receiver front end 20 is illustrated along with several other components to illustrate how it fits in to a transceiver. As shown, the receiver front end 20 is connected to an antenna 22 by way of a cable 24. The output of the receiver front end 20 is connected to a intermediate frequency (IF) amp 26, for example, by way of strip line, microstrip or coaxial cable 28. The output 30 of IF amp 26 is connected to the balance of receiver circuit. For simplicity, only a transmit amplifier portion 32 of the transmitter circuit portion of the transceiver is illustrated. The input to the transmit amplifier 32, generally identified with the reference numeral 34, is conventional and is not illustrated for simplicity. The output of the transmit amplifier 32, generally identified with the reference numeral 36, is applied to a frequency diplexer 38.

Referring to FIG. 1, the exemplary receiver front end 20 includes the frequency diplexer 38, a pre filter 40, a low-noise amplifier 42 and a mixer 44. These components form the receiver front end and are enclosed by a dashed box, identified with the reference numeral 20. All of these components in the receiver front end 20 may be formed from conventional semiconductor technology and in fact from off-the-shelf components and enclosed in a commercially available off-the-shelf refrigerator, for example, a Cyromech Model No. AL300 refrigerator.

The frequency diplexer 38, pre filter 40, LNA 42 and mixer 44 are all formed from conventional semiconductor technology, for example, GaAs, AlGaAs/GaAs heterojunction bipolar transistor (HBT) devices. The frequency diplexer 38, final filter 40, LNA 42 and mixer 44 may be formed from one or more monolithic microwave integrated circuits (MMIC). One or more of these MMICs may be housed in the refrigerator for cooling the devices as discussed above to reduce the system noise figure.

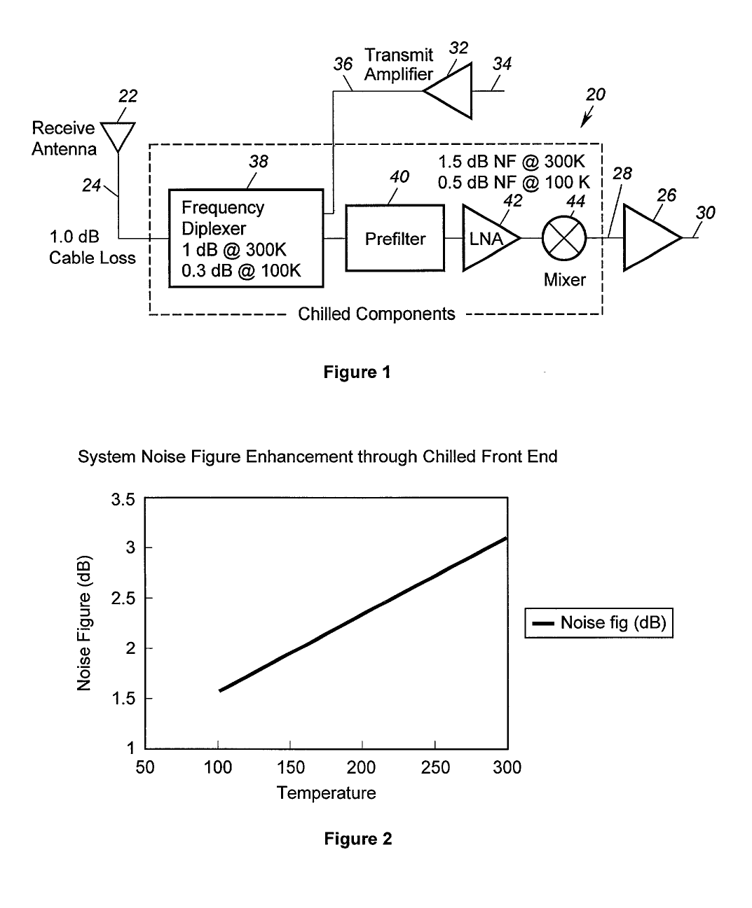

As mentioned above, all of the components in the receiver front end 20 are formed from conventional semiconductor technology. As such, the problems associated with use of superconducting circuits are virtually eliminated. For example, the receiver front end 20 in accordance with the present invention will be compatible with the balance of the components forming the transceiver 20 since the receiver front end 20 is formed from conventional semiconductor technology. In addition, as illustrated in FIG. 2, the noise figure performance of the receiver front end 20 tends to be linear with respect to temperature. The modest degradation of the noise figure performance above cryogenic temperatures allows the elimination of redundant transceiver components to compensate for cooler failure. More particularly, transceivers based on superconducting components normally are formed with redundant components to provide continuous performance in the event of a cooler failure because of the drastic change in performance of such superconductor materials when the cooler fails. The present invention minimizes if not eliminates the need for redundant components since the noise figure performance gradually changes on cooler failure.

Since the components of the receiver front end 20 are based on conventional semiconductor technologies and off-the-shelf components, various embodiments of the individual components, such as the frequency diplexer 38, pre filter 40, LNA 42 and mixer 44 are contemplated. For example, an LNA with low-noise figure performance at relatively low temperatures as discussed above is disclosed in “A Space DC-3 GHz Cryogenic AlGaAs/GaAs HBT Low-Noise MMIC with 0.15 bB Noise Figure,” by Kobayashi et al., IEDM Technical International Electron Devices Meeting, pages 775-778, Dec. 5-8, 1999, hereby incorporated by reference.

The diplexer 38 and filter 40 may be a commercially available diplexer filter, at available from K & L, Model No. WSD-0064. The diplexer filter separates the transmit and receive channels from the antenna and provides relatively high isolation between the transmit and receive channels. More particularly, minimizing power loss in the transmitter chain is critical. Any loss is the diplexer must be compensated by increased power and increased power handling capacity of the transmit amplifier. In the case of multi-carrier wireless systems, power handling capacity of transmit power amplifier strongly affects the total system size, weight and cost.

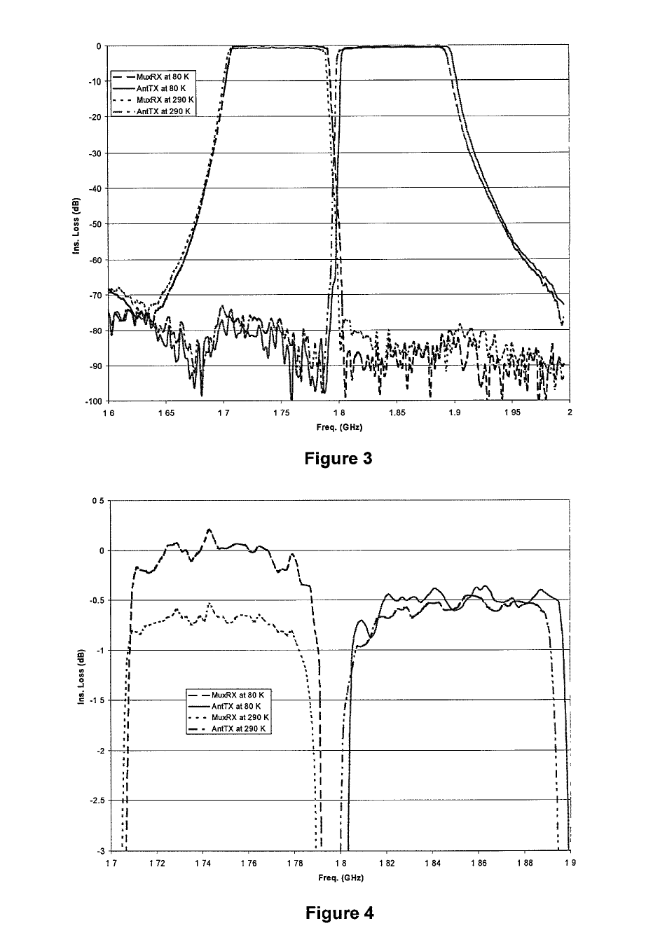

Losses in the commercial filters are predominately due to resistive losses in the elements and dielectric loss. As illustrated in FIG. 3, cooling can significantly reduce these losses and improve filter performance. As shown, the sharpness in the filter cut-off is improved which is important for transmit/receive isolation while the insertion loss tends to be decreased. FIG. 4 is an enlarged view of the insertion loss for type WSD-0064 diplexer. As shown the receive/band loss reduces within an experimental uncertainty of 0 when cooled to 80° K.

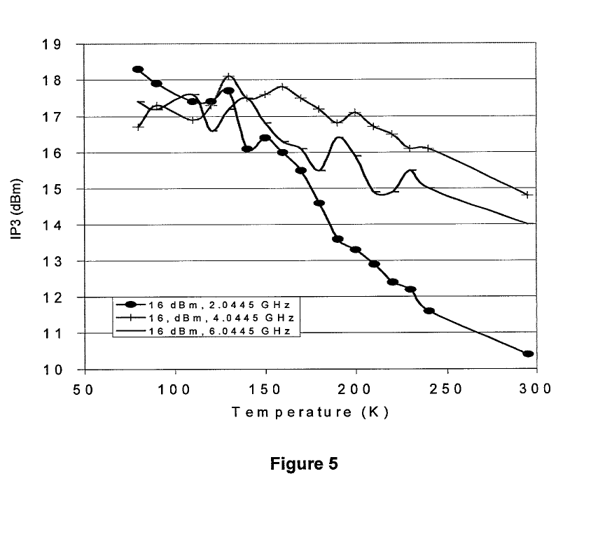

A TRW model IMA-8 typifies the benefits of cooling the mixer. As shown in FIG. 5, cooling of the mixer 44 also enhances the receiver performance. The key aspect of wireless receiver performance is dynamic range. Large signals introduced into the receive bandwidth tend to cross-modulate and swamp low-power signals. Often the mixer drastically limits dynamic range in a receiver chain. Mixers enhances the dynamic range in two ways. First, mixer thermal noise decreases as temperature is reduced. Second, the power handling capacity of the mixers tend to increase at lower temperatures. As shown in FIG. 5, the power handling capacity (third order intercept, IP3) is improved by the cooling.

Obviously, many modification and variations of the present invention are possible in light of the above teachings. For example, thus, it is to be understood that, within the scope of the appended claims, the invention may be practiced otherwise than as specifically described above.

What is claimed and desired to be secured by Letters Patent of the United States is:

We claim:

1. A receiver front end with improved noise figure performance comprising:
a receiver front end; and
a refrigerator for cooling said receiver front end during operation.

2. A portion of a receiver front end with improved noise figure performance for use in a communication system comprising:
a filter, formed from non-superconducting materials;
a low-noise amplifier (LNA), coupled to said filter formed from non-superconducting materials; and
a refrigerator for cooling said filter and said LNA during operation.

3. A portion of a receiver front end with improved noise figure performance for use if a communication system comprising:
a filter, formed from non-superconducting materials;
a low-noise amplifier (LNA), coupled to said filter formed from non-superconducting materials;
a mixer, coupled to said LNA formed from non-superconducting materials connected to said LNA; and
a refrigerator for cooling said filter, LNA and said mixer during operation.

4. A receiver front end with improved noise figure performance for use in a communication system comprising:
a frequency diplexer formed from non-superconducting materials;
a filter, coupled to said frequency diplexer, formed from non-superconducting materials;
a low-noise amplifier (LNA), coupled to said filter, formed from non-superconducting materials and attached to said filter;
a mixer, coupled to said LNA from non-superconducting materials attached to said LNA; and
a refrigerator for cooling said frequency diplexer filter, LNA and said mixer during operation.

5. A method for forming a receiver front end with improved noise figure performance for use in a communication system comprising the steps of:
(a) forming a duplexer from non-superconducting materials;
(b) forming a filter from non-superconductive materials;
(c) forming a low-noise amplifier from non-superconducting materials;
(d) connecting filter and said LNA; and
(e) disposing said filter and LNA in a refrigerator for cooling said filter and LNA during operation.

6. A method for forming at least a portion of a communication system with increased noise performance comprising the steps of:
(a) forming two or more components of said communication system from non-superconducting materials; and
(b) disposing said components in a refrigerator for cooling said components during operation.

7. A method for forming at least a portion of a communication system with increased noise figure performance comprising the steps of:
(a) forming a receiver front end from one or more components formed from non-superconducting materials; and
(b) disposing said receiver front end in a refrigerator for cooling said components during operation.

8. A method for forming a communication system with increased noise figure performance comprising the steps of:
(a) forming two or more components of a receiver front end from non-superconducting materials;
(b) disposing said two or more components in a refrigerator for cooling said components during operation.

9. A method for forming a communication system with increased noise figure performance comprising the steps of:
(a) forming three or more components of a receiver front end from non-superconducting materials;
(b) disposing said three or more components in a refrigerator for cooling said components during operation.

10. A transceiver front end with improved noise figure performance comprising:
a transceiver front end; and
a refrigerator for cooling said transceiver front end during operation.

11. A portion of a transceiver front end with improved noise figure performance for use in a commumcation system comprising:
a filter, formed from non-superconducting materials;
a low-noise amplifier (LNA), coupled to said filter formed from non-superconducting materials; and
a refrigerator for cooling said filter and said LNA during operation.

12. A portion of a transceiver front end with improved noise figure performance for use if a communication system comprising:
a filter, formed from non-superconducting materials;
a low-noise amplifier (LNA), coupled to said filter formed from non-superconducting materials;
a mixer, coupled to said LNA formed from non-superconducting materials connected to said LNA; and
a refrigerator for cooling said filter, LNA and said mixer during operation.

13. A transmitter front end with improved noise figure performance for use in a communication system comprising:
a frequency diplexer formed from non-superconducting materials;
a filter, coupled to said frequency diplexer, formed from non-superconducting materials;
a low-noise amplifier (LNA), coupled to said filter, formed from non-superconducting materials and attached to said filter;
a mixer, coupled to said LNA from non-superconducting materials attached to said LNA; and
a refrigerator for cooling said frequency diplexer filter, LNA and said mixer during operation.

14. A method for forming a transceiver front end with improved noise figure performance for use in a communication system comprising the steps of:
(a) forming a duplexer from non-superconducting materials;
(b) forming a filter from non-superconductive materials;
(c) forming a low-noise amplifier from non-superconducting materials;
(d) connecting filter and said LNA; and
(e) disposing said filter and LNA in a refrigerator for cooling said filter and LNA during operation.

15. A method for forming at least a portion of a communication system with increased noise performance comprising the steps of:
(a) forming two or more components of said communication system from non-superconducting materials; and
(b) disposing said components in a refrigerator for cooling said components during operation.

16. A method for forming at least a portion of a communication system with increased noise figure performance comprising the steps of:
(a) forming a transceiver front end from one or more components formed from non-superconducting materials; and
(b) disposing said transceiver front end in a refrigerator for cooling said components during operation.

17. A method for forming a communication system with increased noise figure performance comprising the steps of:
(a) forming two or more components of a transceiver front end from non-superconducting materials;
(b) disposing said two or more components in a refrigerator for cooling said components during operation.
